(19) United States
(12) Patent Application Publication
(10) Pub. No.: US 2004/0044618 A1
(43) Pub. Date: Mar. 4, 2004

(54) Device and method of processing charges for provision of information

(76) Inventors: Hideaki Tanaka, Nara (JP); Keisuke Iwasaki, Nara (JP); Yoshihiro Kitamura, Osaka (JP); Toru Kawata, Hyogo (JP)

Correspondence Address: EDWARDS & ANGELL, LLP, P.O. BOX 9169, BOSTON, MA, 02209, US

(21) Appl. No.: 10/381,092

(22) PCT Filed: Sep. 20, 2001
(86) PCT No.: PCT/JP01/08215

(30) Foreign Application Priority Data
Sep. 29, 2000 (JP) 2000-29838.3

(51) Int. Cl. G06F 17/60

(52) U.S. Cl. 705/39

(57) ABSTRACT

A charge processing device (100) for use in an information sale system using a network includes: a circuit receiving from a user terminal (500) subscription request data including an information ID specifying information and a viewer ID specifying a user terminal; a circuit receiving from a distribution server (400) an information ID specifying information, an author ID specifying an author of information and a publishing company ID specifying a publishing company of information; a collecting unit responsive to reception of the subscription request data from the user terminal (500) for collecting charges from users based on the received information; a circuit transmitting subscription approval data to the user terminal (500); and a circuit transmitting information of charges to servers (200, 300, 400, 600, 700).

### TECHNICAL FIELD

The present invention generally relates to a technique for distributing information over a network, and more particularly to a technique for processing charges for distributed information.

### BACKGROUND ART

Recently, with development of networks including the Internet, electronic books are sold through on-line communication or distribution of recording mediums that stores information. Japanese Patent Laying-Open No. 2000-113050 discloses a system for selling electronic books in such a manner.

In the system disclosed in this publication, text documents, diagrams, tables, and images are electronically converted to create electronic books. The electronic books are distributed to the users. The user can read the content of an electronic book only by executing a particular procedure. The electronic book system includes an electronic bookstore computer for creating and selling electronic books and an electronic book viewer for purchasing, managing and viewing electronic books. The electronic bookstore computer includes a distributing circuit distributing to the users information enciphered using a viewing key for each electronic book to prevent viewing of partial information of an electronic book, a transmitting circuit selling and distributing a viewing key decoding encryption, and a control circuit controlling the distributing circuit and the communication circuit. The electronic book viewer includes a receiving circuit receiving a viewing key for an electronic book and an output circuit decoding encryption by the viewing key and outputting the content of the electronic book.

According to the electronic book system disclosed in this publication, the electronic bookstore that is a publisher of electronic books distributes electronic books in a manner that an electronic book can only read by the electronic book viewer dedicated to display the electronic book. In doing so, the electronic bookstore distributes the electronic book with its information partially enciphered by the viewing key dedicated to that electronic book. In the enciphered electronic book, its partial information cannot be read without the viewing key. The user views the information other than that partial information to determine whether to acquire the entire information. If the user wishes to acquire the entire information, the user acquires the viewing key upon payment. The user uses the acquired viewing key to decode the encryption and view the entire information.

In the electronic book system disclosed in the aforementioned publication, the electronic bookstore receives the consideration for the sold, viewing key. This is not only the case with this electronic book system. In many cases, when electronic books partially enciphered are distributed, the consideration for the viewing key decoding ciphers are provided only to the seller of electronic books. Therefore third parties involved in distribution and viewing of electronic books, other than the electronic book seller, cannot receive profits. As a result, such an electronic book system cannot become widespread.

An object of the present invention is therefore to provide a charge processing device and a charge processing method to allow charges collected for distribution of information to be properly processed.

Another object of the present invention is to provide a charge processing device and a charge processing method to allow an electronic book system using a network to be widely used, through proper processing for charges collected for distribution of information.

A further object of the present invention is to provide a charge processing device and a charge processing method to reduce financial burdens on the users who receive information.

Still another object of the present invention is to provide a charge processing device and a charge processing method to allow charges collected from the users to be widely allocated.

Yet another object of the present invention is to provide a charge processing device and a charge processing method to allow charges collected from the users to be allocated to the parties committed to provision of information to the users.

### DISCLOSURE OF THE INVENTION

A charge processing device in accordance with the present invention collects a charge for provision of information from a user receiving the information and processes the charge being collected. The charge processing device includes: a receiving circuit connected to a terminal used by the user to view the information for receiving from the terminal first data for specifying information received by the user and second data for specifying the terminal; a collecting circuit collecting the charge for provision of information from the user based on the first data; and a transmitting circuit connected to the collecting circuit and the receiving circuit for transmitting information of the charge collected by the collecting circuit to a first destination and a second destination separately in accordance with the first data and the second data.

According to the present invention, the receiving circuit receives first data for specifying information and second data for specifying a user terminal from a user receiving information from a distribution server or the like. The transmitting circuit transmits information of the collected charge separately to a creator, a publisher, etc. of information specified by the first data and to a manufacture etc. of a user terminal specified by the second data. Therefore the charge for provision of information that is collected from the user is allocated not only to a creator or a publisher of the information but also to a maker manufacturing a terminal for viewing the information. As a result, the consideration for distribution of information can be handled appropriately. Thus, an electronic book system and the like using a network can achieve widespread use.

More preferably, the receiving circuit includes a circuit receiving third data for specifying a distributor of information received by the user, in addition to the first data and the second data. The transmitting circuit includes a circuit transmitting the information of the charge to a first destination, a second destination and a third destination separately in accordance with the first data, the second data and the third data.

According to the present invention, the charge for provision of information is also allocated, for example, to a distributor that distributes information to the user using a distribution server, a distributor that delivers a recording medium having recorded information, and the like. As a result, the consideration for distribution of information can be appropriately handled. Thus, an electronic book system and the like using a network can achieve widespread use.

More preferably, the transmitting circuit includes a circuit transmitting the information of the charge to one separated from the first destination that is involved in creation of the information and is permitted to receive the information of the charge, in accordance with the first data. Here, the one that is involved in creation of the information and is permitted to receive the information of the charge is specifically an author, a creator, an editor, etc. of the information.

According to the present invention, the transmitting circuit allows transmission of the information of the charge to an author as a creator of information, a publishing company as a publisher of information, and the like, separately.

More preferably, the transmitting circuit includes a circuit transmitting the information of the charge to one separated from the second destination that is involved in at least one of development and sale of the terminal and is permitted to receive the information of the charge, in accordance with the second data. Here, the one that that is involved in at least one of development and sale of the terminal and is permitted to receive the information of the charge is specifically a hardware developer and a software developer of the terminal, a seller of the terminal, and the like.

According to the present invention, the transmitting circuit allows transmission of the information of the charge separately to a hardware producer of a terminal used by the user to view information, a software producer of the terminal, and the like.

More preferably, the information includes information body and advertising data, and the collecting circuit includes a circuit collecting an advertising fee from an advertiser of the advertising data, in addition to the charge for provision of information from the user. The transmitting circuit includes a circuit transmitting information of the charge and the advertising fee collected by the collecting circuit, to the destinations separately.

According to the present invention, the charge for provision of information collected from the user and the advertising fee collected from the advertiser are allocated not only to a creator or a publisher of information but also to a maker manufacturing a terminal for viewing information. As a result, the charge for distribution of information and the advertising fee collected from the advertiser can be handled appropriately. Thus, an electronic book system and the like using a network can achieve widespread use.

In accordance with another aspect, the present invention provides a charge processing method of collecting a charge for provision of information from a user receiving the information and processing the charge being collected. The charge processing method includes the steps of: receiving from a terminal used by the user to view the information first data for specifying information received by the user and second data for specifying the terminal; collecting the charge for provision of information from the user based on the first data; and transmitting information of the charge collected at the step of collecting the charge to a first destination and a second destination separately in accordance with the first data and the second data.

According to the present invention, the first data for specifying information and the second data for specifying a user terminal are received from the user receiving the information from a distribution server or the like. Information of the collected charge is transmitted separately to a creator, a publisher, etc. of the information specified by the first data and to a manufacture etc. of the user terminal specified by the second data. Therefore the charge for provision of information collected from the user is allocated not only to a creator or a publisher of the information but also to a maker manufacturing the terminal for viewing the information. As a result, the consideration for distribution of information can be handled appropriately. Thus, an electronic book system and the like using a network can become widespread.

In accordance with a further aspect, the present invention provides a computer readable recording medium storing a program implementing a charge processing method of collecting a charge for provision of information from a user receiving the information and processing the charge being collected. The charge processing method including the steps of: receiving from a terminal used by the user to view the information first data for specifying information received by the user and second data for specifying the terminal; collecting the charge for provision of information from the user based on the first data; and transmitting information of the charge collected at the step of collecting the charge to a first destination and a second destination separately in accordance with the first data and the second data.

According to the present invention, the first data for specifying information and the second data for specifying a user terminal are received from the user receiving the information from a distribution server or the like. Information of the collected charge is transmitted separately to a creator, a publisher, etc. of the information specified by the first data and to a manufacture etc. of the user terminal specified by the second data. Therefore the charge for provision of information collected from the user is allocated not only to a creator or a publisher of the information but also to a maker manufacturing a terminal for viewing information. As a result, the consideration for distribution of information can be handled appropriately. Thus, an electronic book system and the like using a network can achieve widespread use.

### BRIEF DESCRIPTION OF THE DRAWINGS

FIG. 1 is an overall configuration diagram of an electronic information sale system including a charge processing device in accordance with an embodiment of the present invention.

FIG. 2 is a diagram illustrating information sent from a publishing company server to a distribution server.

FIG. 3 is a diagram illustrating information for user terminal sent from the distribution sever to a user terminal.

FIG. 4 is a diagram illustrating information-specifying data sent from the distribution server to the charge processing device.

FIG. 5 is a diagram illustrating subscription request data sent from the user terminal to the charge processing device.

FIG. 6 is a diagram illustrating subscription approval data sent from the charge processing device to the user terminal.

FIG. 7 is an external view of a computer implementing the charge processing device in accordance with the embodiment of the present invention.

FIG. 8 is a control block diagram of the computer shown in FIG. 7.

FIGS. 9 and 10 are tables representing distribution ratios stored in a fixed disk of the charge processing device.

FIG. 11 is a control block diagram of the user terminal.

FIG. 12 is a flow chart showing a control procedure of an information creating process in the distribution server in accordance with the embodiment of the present invention.

FIG. 13 is a flow chart showing a control procedure of an information distributing process in the distribution server in accordance with the embodiment of the present invention.

FIG. 14 is a flow chart showing a control procedure of a trial process in the user terminal in accordance with the embodiment of the present invention.

FIG. 15 is a flow chart showing a control procedure of a subscription request process in the user terminal and a charging process in the charge processing device in accordance with the embodiment of the present invention.

FIG. 16 is a flow chart showing the control procedure of the charging process in the charge processing device in accordance with the embodiment of the present invention.

### BEST MODES FOR CARRYING OUT THE INVENTION

In the following, an embodiment of the present invention will be described with reference to the figures. In the following description, the same components will be denoted with the same reference characters and provided with the same designations and functions. Therefore the detailed description thereof will not be repeated.

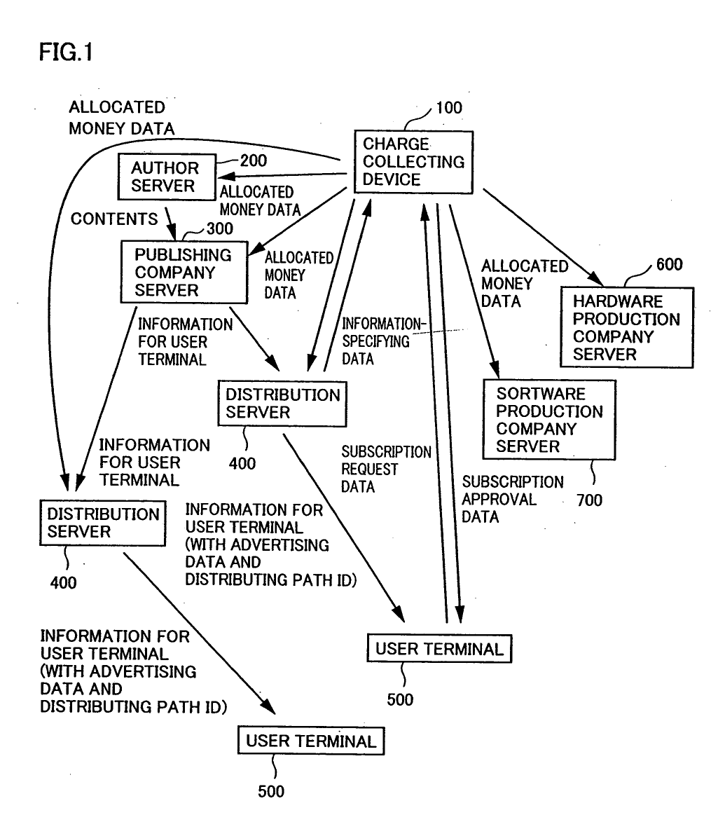

A charge processing device 100 in accordance with the present embodiment is used in an electronic information sale system. Referring to FIG. 1, the electronic information sale system includes charge processing device 100, an author server 200 storing information created by an author, a publishing company server 300 virtually publishing information by sending information received from author server 200 to a distribution server, a distribution server 400 sending adverting data and a distributing path ID (Identification) attached to information received from publishing company 300 to user terminal 500, a user terminal 500 displaying information received from distribution server 400, a server 600 for a company producing hardware of user terminal 500 (referred to as a hardware production company server 600 hereinafter), and a server 700 for a company producing software of user terminal 500 (referred to as a software production company server 700 hereinafter). The servers are connected over a network and can communicate data with each other.

User terminal 500 displays a range available for free subscription (referred to as “trial” hereinafter) in information received from distribution server 400, sends subscription request data for lifting a restriction on a range available for trial to charge collecting server 100, and receives subscription approval data that lifts the restriction on the trial range from charge collecting server 100 to display the entire information. It is noted that the hardware production company and the software production company of user terminal 500 vary depending on kinds of user terminals.

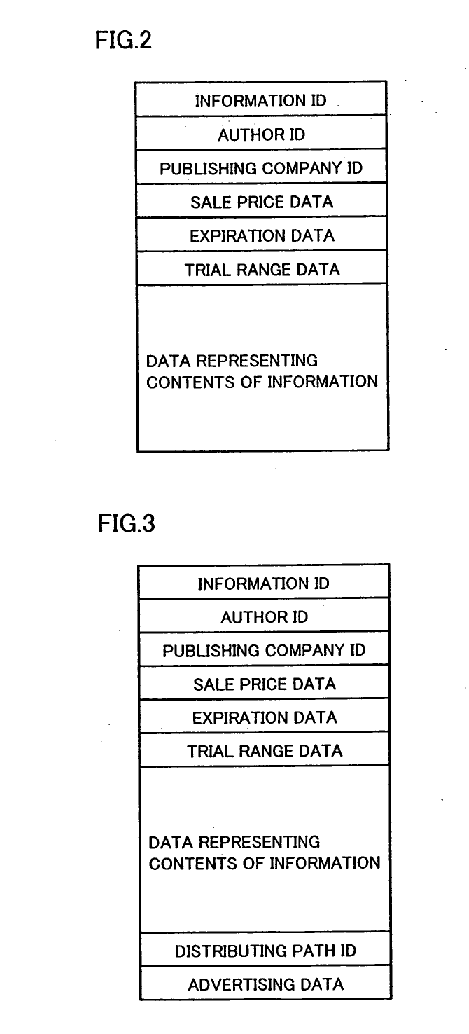

Publishing company server 300 attaches trial range data indicative of the range available for trial to information received from author server 200. The information with the attached trial range data and the like is shown in FIG. 2. As shown in FIG. 2, this information includes an information ID for specifying information, an author ID for specifying the author of this information based on the information ID, a publishing company ID for specifying the publishing company of this information based on this information ID, sale price data of this information, expiration date data indicative of a period during which the subscription of this information is permitted, trial range data, and data representing the content of this information. The trial range data indicates the range of information that allows free subscription at user terminal 500 when the subscription approval data is not received from charge processing device 100. The created information is sent to a plurality of distribution servers 400.

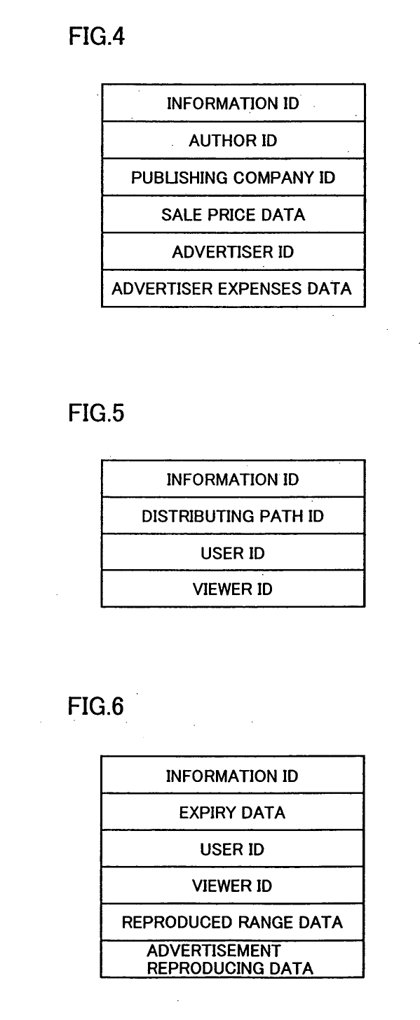

Distribution server 400 creates information for user terminal with the attached advertising data and distributing path ID, and information-specifying data having necessary data being extracted, based on the information received from publishing company server 300 (FIG. 2). The information for user terminal is shown in FIG. 3 and the information-specifying data is shown in FIG. 4.

As shown in FIG. 3, the information for user terminal is created by attaching the distributing path ID and the advertising data to the information shown in FIG. 2. The advertising data is appropriately selected from storage in distribution server 400 and is then attached to the information (FIG. 2). User terminal 100 displays an advertisement based on the advertising data. The distributing path ID specifies an authorized publishing company that virtually publishes information. User terminal 500 distinguishes information published in an authorized manner from information published in an unauthorized manner (for example unauthorized copy of information), based on the distributing path ID. The information for user terminal (FIG. 3) having the attached advertising data and the like is distributed to a plurality of user terminals 500.

As shown in FIG. 4, the information-specifying data includes the information ID, author ID and publishing company ID extracted from the information (FIG. 2). The information-specifying data further includes data indicative of a sale price of information, an advertiser ID for specifying an advertiser of advertising data, and data indicative of expenses borne by the advertiser. Charge processing device 100 specifies requested information based on the information-specifying data when the user terminal 500 requests a subscription. Charge processing device 100 creates allocated money data regarding allocation of a charge for subscription of information, based on the information-specifying data.

User terminal 500 displays to the user the range available for trial in the information received from distribution server 400. Here, the trial range is displayed based on the data indicative of the content of information. If the user reads the trial range and wishes to subscribe to information other than the trial range, the user sends the subscription request data shown in FIG. 5 to charge processing device 100. As shown in FIG. 5, the subscription request data includes an information ID for specifying information for which the user wants to lift the restriction of the trial range, a distributing path ID extracted from the information received by user terminal 500, a user ID for specifying the user, and a viewer ID for specifying user terminal 500.

Once charge processing device 100 receives the subscription request data (FIG. 5) from user terminal 500 and collects the charge from the user, it sends the subscription approval data shown in FIG. 6 to user terminal 500. As shown in FIG. 6, the subscription approval data includes data indicative of an expiry date of subscription, data indicative of a reproduced range, and an advertisement reproducing data for reproducing the advertising data, in addition to the information ID, the user ID and the viewer ID. Based on the data indicative of the reproduced range, the content of information is displayed at user terminal 500. As a result, the user can subscribe to electronic books and the like by viewing the information.

It is noted that allocated money data that is calculated based on a distribution ratio predetermined for each user terminal and information is sent from charge processing device 100 to author server 200, publishing company server 300, distribution server 400, hardware production company server 600, and software production company server 700.

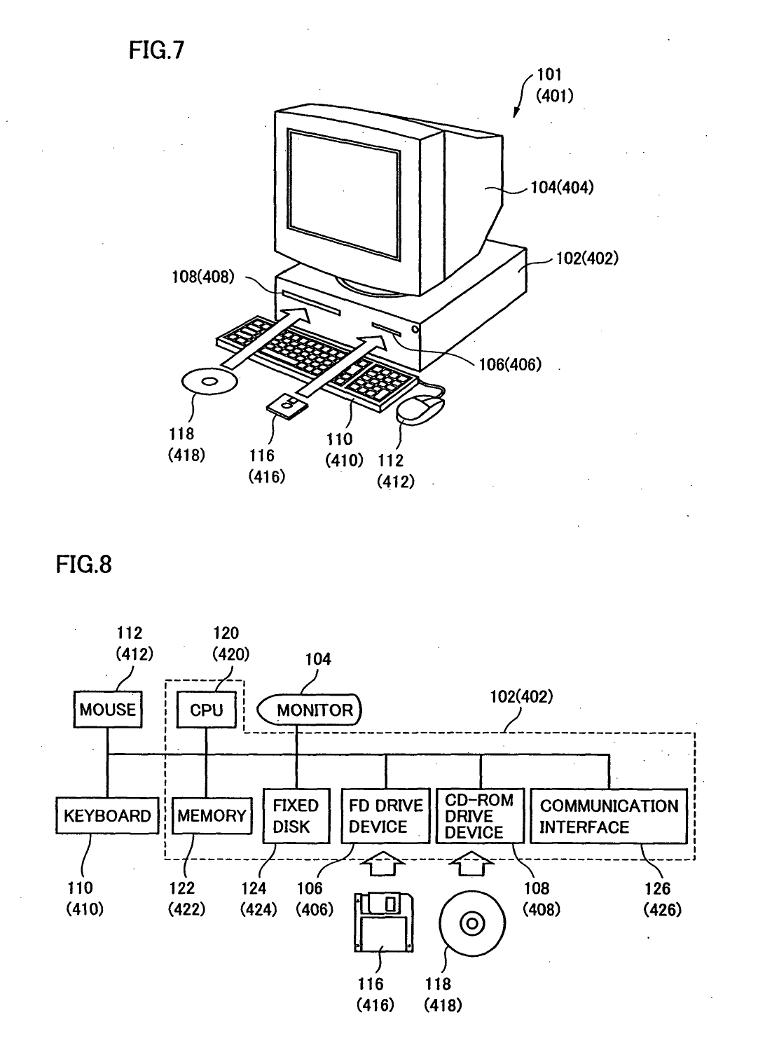

In FIG. 7, an external view of a computer that is an exemplary charge processing device 100 is shown. Referring to FIG. 7, a computer system 101 includes a computer body 102 with a FD (Flexible Disk) drive device 106 and a CD-ROM (Compact Disc-Read Only Memory) drive device 108, a monitor 104, a key board 110, and a mouse 112.

In FIG. 8, the configuration of computer system 101 is shown in a block diagram. As shown in FIG. 8, computer body 102 includes, in addition to FD drive device 106 and CD-ROM drive device 108, a CPU (Central Processing Unit) 120, a memory 122, a fixed disk 124, and a communication interface 126 for communicating with each server, which are connected to each other through buses. A FD 116 is set in FD drive device 106. A CD-ROM 118 is set in CD-ROM drive device 108.

As described above, charge processing device 100 is implemented by computer hardware and software executed by CPU 120. Such software is generally stored in a recording medium such as FD 116 or CD-ROM 118 for distribution, and is read from the recording medium by FD drive device 106, CD-ROM drive device 108 or the like and once stored into fixed disk 124. The software is further read from fixed disk 124 to memory 122 and is then executed by CPU 120. The hardware of the computer shown in FIGS. 7 and 8 is commonly used per se. Therefore the essential part of the present invention consists in the software recorded in a recording medium such as FD 116, CD-ROM 118 or fixed disk 124.

It is noted that the operation of the computer shown in FIGS. 7 and 8 is well known per se and therefore the detailed description thereof will not be repeated herein. Distribution server 400 is also implemented by hardware and software executed by CPU. Therefore the reference numeral for each component of distribution server 400 is shown in FIGS. 7 and 8 in brackets and the detailed description thereof will not be repeated herein.

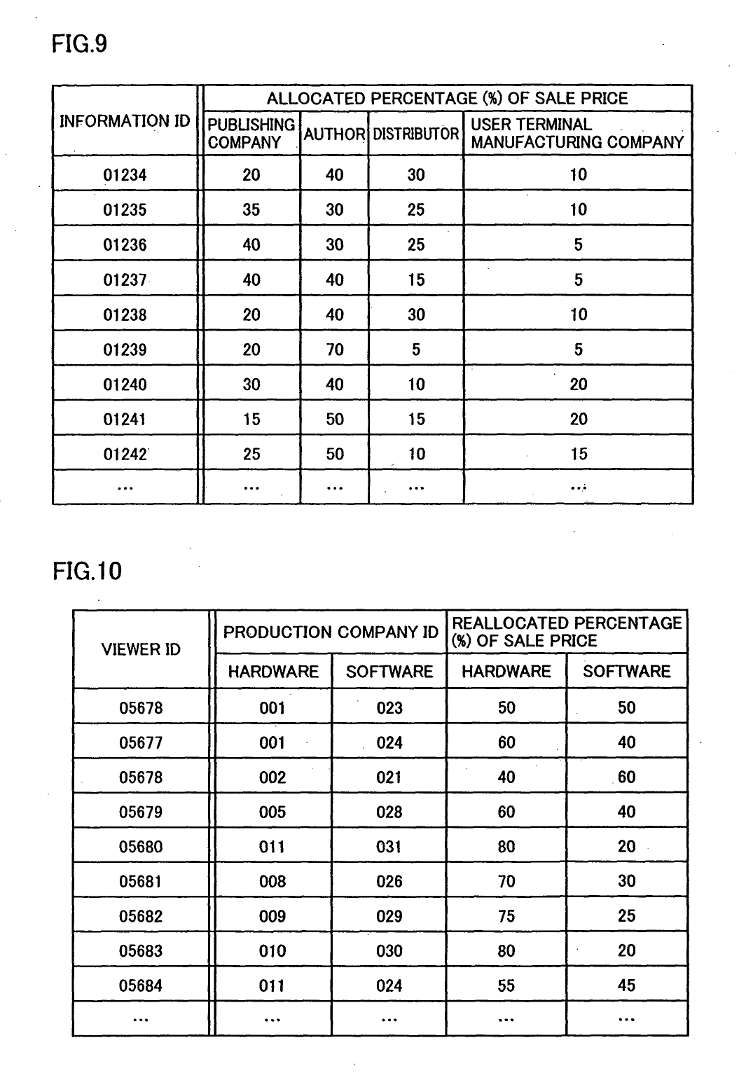

Referring to FIG. 9, an allocation table for a sale price for each information stored in fixed disk 124 of charge processing device 100 will be described. As shown in FIG. 9, the allocation table stores for each information ID, an allocated percentage of the sale price for a publishing company, an author, a distributor, and a user terminal manufacturing company. It is noted that a sale price is a price necessary for a subscription of information, which is defined for each information. That amount of the sale price after deduction of advertiser expenses borne by an advertiser is borne by the user who subscribes to information.

Referring to FIG. 10, an allocation table for each viewer that is stored in flexible disk 124 of charge processing device 100 will be described. As shown in FIG. 10, this allocation table includes for each viewer ID a hardware production company ID for specifying a hardware production company of user terminal 500, a software production company ID for specifying a software production company of user terminal 500, and data representing a reallocated percentage that is an allocation ratio between a hardware production company and a software production company with respect to the allocated percentage for the user terminal manufacturing company shown in FIG. 9. When the viewer ID is indicated by “05679”, for example, the ID of the production company that produces the hardware of the user terminal specified by that viewer ID is “005” and the ID of the production company that produces the software is “028”. It is shown that the reallocated percentage for the hardware production company is 60% and the reallocated percentage for the software production company is 40%. As a result, for the information ID “01234”, the allocated percentage for the hardware production company is 6% (=10%×60%) and the allocated percentage for the software production company is 4% (=10%×40%).

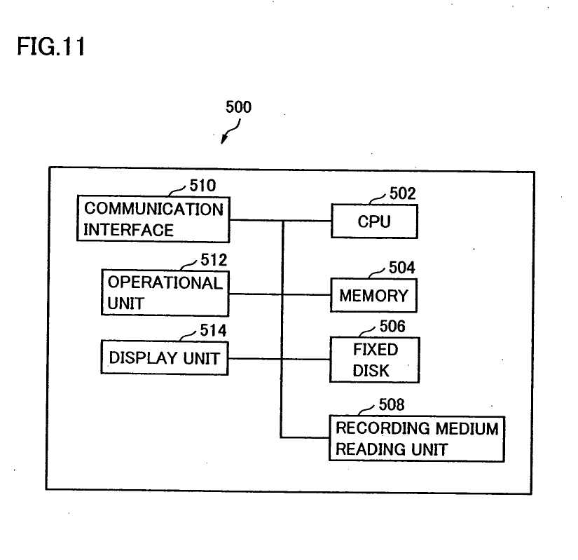

Referring to FIG. 11, user terminal 500 includes a CPU 502 controlling each part of user terminal 500, a memory 504 storing an intermediate result and the like of a program executed by CPU 502, a fixed disk 506 storing information received from distribution server 400, a recording medium reading unit 508 reading a recording medium when information is recorded in the recording medium for delivery, a communication interface 510 for communication with charge processing device 100 and distribution server 400, an operational unit 512 such as a keyboard, and a display unit 514 displaying contents of information. It is noted that these components are connected with each other through buses.

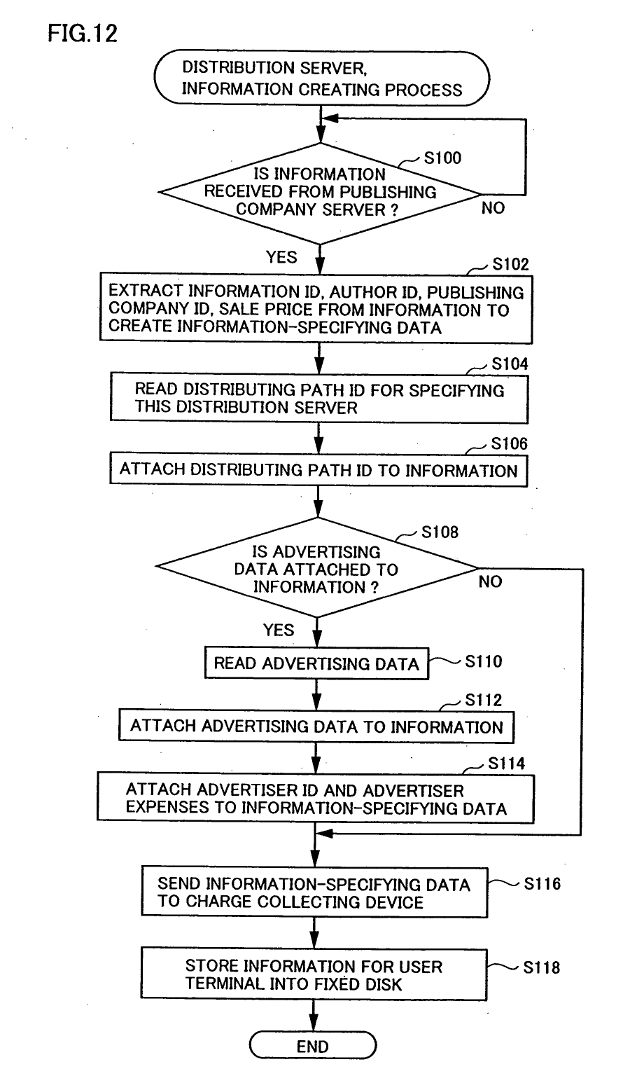

Referring to FIG. 12, the program executed in distribution server 400 has the following control structure in respect of an information creating process.

At step 100 (a step will be abbreviated as S hereinafter), CPU 420 determines whether the information (FIG. 2) is received from publishing company server 300. If the information is received from publishing company server 300 (YES at S100), the process will proceed to S102. If not (NO at S100), reception of information from publishing company server 300 is awaited.

At S102, CPU 420 extracts the information ID, the author ID, the publishing company ID, and the sale price from the received information (FIG. 2) to create information-specifying data (FIG. 4). At S104, CPU 420 reads a distributing path ID for specifying this distribution server 400 from fixed disk 424. It is noted that the distributing path ID is set for each distribution server in advance to allow a distribution server to be specified. At S106, CPU 420 attaches the read, distributing path ID to the received information (FIG. 2).

At S108, CPU 420 determines whether advertising data is attached to the information. This determination is made based on advertisement attaching information (an advertising data attaching flag, an advertisement kind ID, an advertiser ID, and the like) which is predetermined for each information. If advertising data is attached to the information (YES at S108), the process will proceed to S110. If not (NO at S108), the process will proceed to S116.

At S110, CPU 420 reads advertising data stored in fixed disk 424 based on the advertisement attaching information. Here, the advertiser ID and the expenses borne by the advertiser are read along with the advertising data. At S112, CPU 420 attaches the advertising data to the received information (FIG. 2) to create information for user terminal (FIG. 3).

At S114, CPU 420 attaches the advertiser ID and the advertiser expenses to the created information-specifying data.

At S116, CPU 420 sends the information-specifying data (FIG. 4) to charge processing device 100. At S118, CPU 420 stores the information for user terminal (FIG. 3) into fixed disk 424.

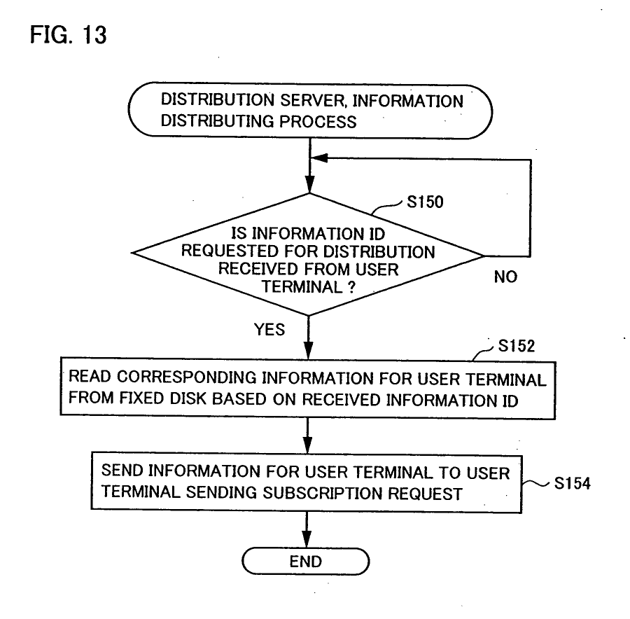

Referring to FIG. 13, the program executed in distribution server 400 has the following control structure in respect of an information distributing process.

At S150, CPU 420 determines whether the ID of the information requested to be distributed is received from user terminal 500. In response to the user entering the information ID that specifies the desired information for trial from operational unit 512 of user terminal 500, and pressing a send button, distribution server 400 receives from user terminal 100 the information ID requested to be distributed. When the information ID requested to be distributed is received from user terminal 100 (YES at S150), the process will proceed to S152. If not (NO at S150), reception of information ID from user terminal 100 is awaited.

At S152, CPU 420 reads the information for user terminal (FIG. 3) from fixed disk 424 based on the received information ID. At S154, CPU 420 sends the read information for user terminal to user terminal 500 that has sent a distribution request.

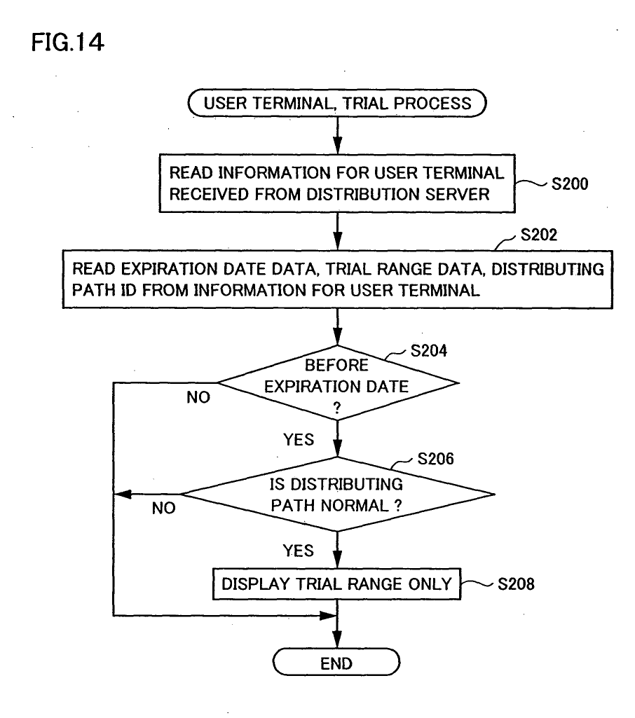

Referring to FIG. 14, the program executed in user terminal 500 has the following control structure in respect of a trial process.

At S200, CPU 502 reads from fixed disk 506 the information for user terminal (FIG. 3) received from distribution server 400. It is noted that the information for user terminal received from distribution server 400 is once stored in fixed disk 506. At S202, CPU 502 reads the expiration date data, the trial range data and the distributing path ID from the read data.

At S204, CPU 502 determines whether the present date and time is prior to the expiration date based on the present date and time and the expiration date data using a clock function included in CPU 502. If prior to the expiration date (YES at S204), the process will proceed to S206. If not (NO at S204), this process will end. In a case where the information for user terminal is recorded in a recording medium for delivery, as long as it does not expire, the advertiser bears the advertiser expenses by determining whether it expires or not.

At S206, CPU 502 compares the distributing path ID included in the information for user terminal with a table storing authorized distributing paths in advance, to determine whether the distributing path is normal. The authorized distributing path is stored in fixed disk 506 in advance. If the distributing path is normal (YES at S206), the process will proceed to S208. If not (NO at S206), this process will end. The distributing path is not normal, for example, when such information for user terminal is received that includes a distributing path ID that is not stored in fixed disk 506 as an authorized distributing path.

At S208, CPU 502 presents only a trial range on display unit 214, based on the trial range data of the information for user terminal.

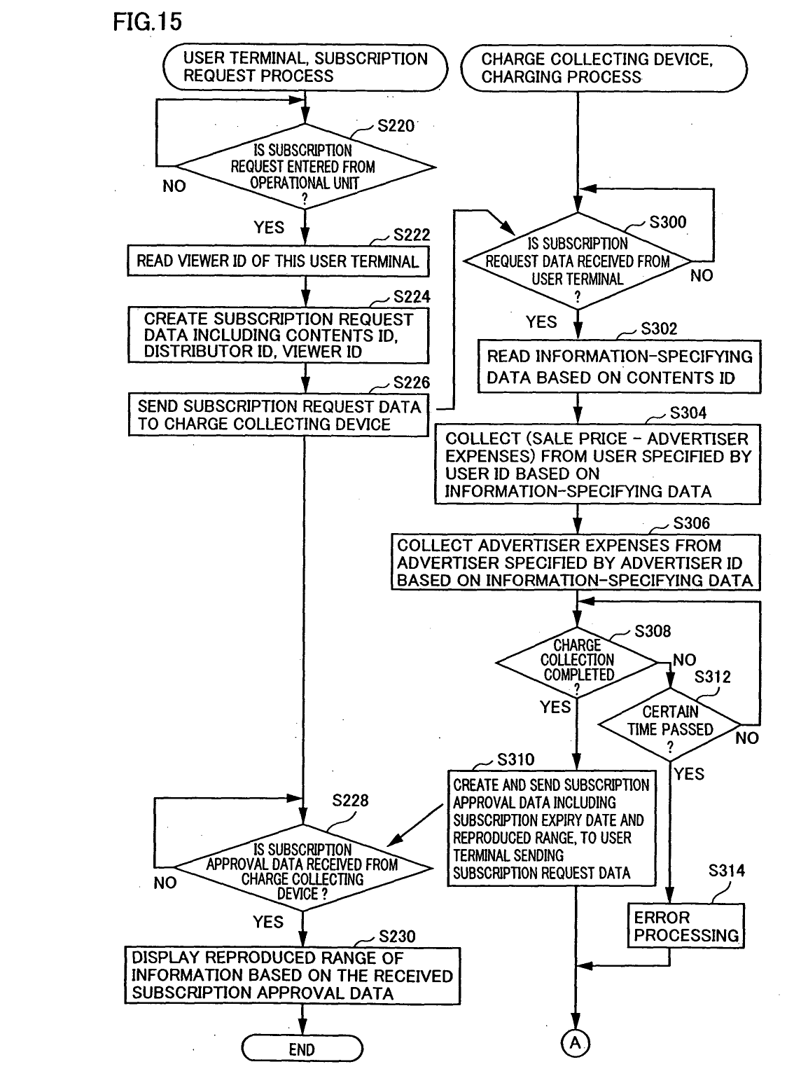

Referring to FIG. 15, the program executed in user terminal 500 and the program executed in charge processing device 100 have the following control structures in respect of a subscription request process and a charging process, respectively.

At S220, CPU 502 determines whether a subscription request is entered from operational unit 512. The subscription request is made when the user requests to subscribe to the entire information as a result of trial. If the subscription request is entered from operational unit 512 (YES at S220), the process will proceed to S220. If not (NO at S220), entering of a subscription request from operational unit 512 is awaited.

At S222, CPU 502 reads the viewer ID of this user terminal 500 from fixed disk 506. The viewer ID is stored in fixed disk 506 in advance to allow the kind of user terminal to be specified. At S224, CPU 502 creates subscription request data (FIG. 5) including the information ID and distributing path ID extracted from the information for user terminal (FIG. 3) and the read viewer ID. At S226, CPU 502 sends the created subscription request data to charge processing device 100.

CPU 120 of charge processing device 100 determines whether the subscription request data is received from user terminal 500. If the subscription request data is received from user terminal 500 (YES at S300), the process will proceed to S302. If not (NO at S300), reception of subscription request data from user terminal 500 is awaited.

At S302, CPU 120 reads the information-specifying data (FIG. 4) based on the information ID of the received subscription request data. This information-specifying data is stored in fixed disk 124 as described above. At S304, CPU 120 collects (the sale price—the advertiser expenses) from the user specified by the user ID, based on the read information-specifying data. At S306, CPU 120 collects the advertiser expenses from the advertiser specified by the advertiser ID, based on the information-specifying data. At S304 and S306, the charges may be collected using an on-line settlement, a settlement with electronic money, and any other settlement.

At S308, CPU 120 determines whether the process of collecting the charge from the user and the advertiser is completed. If the process of collecting the charge is completed (YES at S308), the process will proceed to S310. If not (NO at S308), the process will proceed to S312.

At S312, CPU 120 determines whether a predetermined time has passed from the start of the process of collecting the charge. If a predetermined time has passed from the start of the process of collecting the charge (YES at S312), the process will proceed to S314. If not (NO at S312), the process will return to S308, waiting for the completion of the process of collecting the charge.

At S314, CPU 120 performs error processing based on that the charging process does not end before a predetermined time has passed. When the advertiser expenses cannot be collected from the advertiser, for example, user terminal 500 is informed that the advertiser expenses cannot be collected from the advertiser.

At S310, CPU 120 creates and sends subscription approval data (FIG. 6) including an expiry date and a reproduced range that allows subscription of information, to the user who has sent the subscription request data.

At S228, CPU 500 of user terminal 500 determines whether the subscription approval data is received from charge processing device 100. If the subscription approval data is received from charge processing device 100 (YES at S228), the process will proceed to S230. If not (NO at S228), reception of subscription approval data from charge processing device 100 is awaited.

At S230, CPU 502 reproduces and presents information on display unit 514 based on the subscription approval data. Here, based on the advertisement reproducing data included in the subscription approval data, the advertising data included in the information for user terminal (FIG. 3) is reproduced and the advertisement appears on display unit 514.

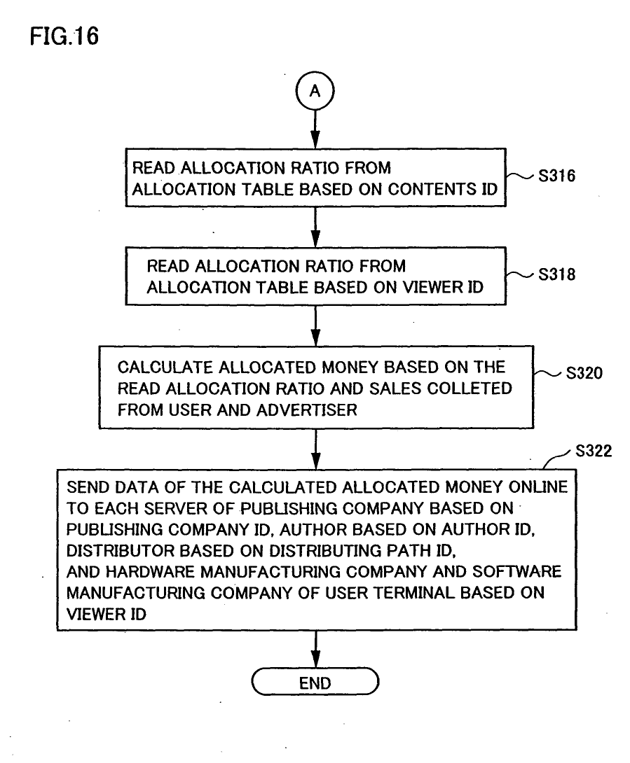

Referring to FIG. 16, at S316, CPU 120 reads the allocation ratio from the allocation table (FIG. 9) based on the information ID included in the subscription request data received from user terminal 500. The allocation table as used here is stored in fixed disk 124 in advance.

At S318, CPU 120 reads an allocation ratio defined for each viewer ID from the allocation table (FIG. 10) based on the viewer ID included in the subscription request data. The allocation table as used here is stored in fixed disk 124 in advance.

At S320, CPU 120 calculates allocated money based on the read allocation ratio and the sales collected from the user and the advertiser. At S322, CPU 120 sends the allocated money data concerning the calculated, allocated money to author server 200 based on the author ID, publishing company server 300 based on the publishing company ID, distribution server 400 based on the distributing path ID, and hardware production company server 600 of user terminal 500 and software production company server 700 of user terminal 500 based on the viewer ID.

The operation of charge processing device 100 based on the structure and flow chart as described above will be described.

Author server 200 sends information created by an author to publishing company server 300. Publishing company server 300 sends the information (FIG. 2) to distribution server 400 for virtual publication of the information. Distribution server 400 sends the information-specifying data (FIG. 4) created based on the information (FIG. 2) to charge processing device 100. Distribution server 400 creates information for user terminal (FIG. 3) based on the information (FIG. 2).

In this state, the information ID for specifying the subscription-requested information is sent from user terminal 500 to distribution server 400, and the information for user terminal (FIG. 3) corresponding to the received information ID is sent from distribution server 400. Here, user terminal 500 as receiving the information displays only a range available for trial on display unit 514 based on the trial range data.

Depending on the contents of the trial range appearing on display unit 514 of user terminal 500, if the user wishes for subscription to the entire information, subscription request data is sent to charge processing device 100 (S226). In response, charge processing device 100 receives the subscription request data from user terminal 500 (YES at S300). Once the subscription request is received from user terminal 500, charge processing device 100 reads the information-specifying data (FIG. 4) from fixed disk 124 based on the information ID included in the received subscription request data (FIG. 5) (S302). Charge processing device 100 calculates (the sale price—the advertiser expenses) based on the information-specifying data read from fixed disk 124. The calculated amount of money is collected from the user specified by the user ID included in the subscription request data (S304). Charge processing device 100 collects the advertiser expenses from the advertiser specified by the advertiser ID, based on the advertiser ID and the advertiser expenses included in the information-specifying data (FIG. 4) (S306).

When such a process of collecting the charge is completed within a predetermined time period (YES at S308), charge processing device 100 sends the subscription approval data to user terminal 500 (S310). User terminal 500 that has received the subscription approval data presents the information data and the advertising data included in the information on display unit 514, based on the reproduced range included in the subscription approval data (FIG. 6).

Charge processing device 100 reads the allocation ratio for the sale price from the allocation table (FIG. 9) after collecting the charge (S316). Charge processing device 100 reads the allocation ratio for each viewer from the allocation table (FIG. 10) (S318). Charge processing device 100 calculates money to be allocated to each of the author, the publishing company, the distributor, the hardware production company of the user terminal, and the software production company of the user terminal, based on the read allocation ratios (S320). Charge processing device 100 sends the allocation money data concerning the calculated, allocated money to author server 200, publishing company server 300, distribution server 400, hardware production company server 600, and software production company server 700 (S322).

As described above, the charge processing device in accordance with the present embodiment can allocate the charges collected from the users for information provision not only to creators and publishers of information but also to makers that manufacture terminals for subscription of information. As a result, a charge processing device can be provided where the consideration for distribution of information can be handled appropriately and thus an electronic book system and the like can achieve widespread use using a network.

It is noted that information for user terminal (FIG. 3) with advertising data and a distributing path ID attached thereto may be recorded in a recording medium, which may be delivered to the user, rather than being distributed online over a network. Based on the information for user terminal stored in the recording medium, the user uses user terminal 500 to send subscription request data to charge processing device 100 to receive subscription approval data. Charge processing device 100 in accordance with the present embodiment may be applied to such a delivery using a recording medium.

The embodiment disclosed herein should be understood by way of illustration and not by way of limitation in all respects. The scope of the invention is indicated not by the description above but by the claims, and it is intended that all equivalents to the claim and modifications within the claims should be embraced.

### INDUSTRIAL APPLICABILITY

As described above, according to the charge processing device in the present invention, the charges collected from the users for provision of information and the fees collected from advertisers for presentation of advertisements to the users can be allocated not only to authors who create information and publishing companies that electronically publish information but also to distributors of information and production companies of user terminals displaying information. Therefore the charge processing device in accordance with the present invention is suitable for a system for providing information over a network.

1. A charge processing device that collects a charge for provision of information from a user receiving said information and processes said charge being collected, comprising:
receiving circuit connected to a terminal used by said user to view said information for receiving from said terminal first data for specifying information received by said user;
a collecting circuit collecting said charge for provision of information from said user based on said first data; and
a transmitting circuit connected to said receiving circuit and said collecting circuit for transmitting to a first destination information of the charge collected by said collecting circuit in accordance with said first data.

2. A charge processing device that collects a charge for provision of information from a user receiving said information and processes said charge being collected, comprising:
a receiving circuit connected to a terminal used by said user to view said information for receiving from said terminal first data for specifying information received by said user and second data for specifying said terminal;
a collecting circuit collecting said charge for provision of information from said user based on said first data; and
a transmitting circuit connected to said collecting circuit and said receiving circuit for transmitting information of the charge collected by said collecting circuit to a first destination and a second destination separately in accordance with said first data and said second data.

3. The charge processing device according to claim 2, wherein
said receiving circuit includes a circuit receiving third data for specifying a distributor of information received by said user, in addition to said first data and said second data, and
said transmitting circuit includes a circuit transmitting said information of the charge to a first destination, a second destination and a third destination separately in accordance with said first data, said second data and said third data.

4. The charge processing device according to claim 1 or 2, wherein
said transmitting circuit includes a circuit transmitting said information of the charge to one separated from said first destination that is involved in creation of said information and is permitted to receive said information of the charge, in accordance with said first data.

5. The charge processing device according to claim 2, wherein
said transmitting circuit includes a circuit transmitting said information of the charge to one separated from said second destination that is involved in at least one of development and sale of said terminal and is permitted to receive said information of the charge, in accordance with said second data.

6. The charge processing device according to claim 1 or 2, wherein
said information includes data representing contents of information and advertising data, and said collecting circuit includes a circuit collecting an advertising fee from an advertiser of said advertising data, in addition to said charge for provision of information from said user, and
said transmitting circuit includes a circuit transmitting information of said charge and said advertising fee collected by said collecting circuit, to said destinations separately.

7. A charge processing device that collects a charge for provision of information from a user receiving said information and processing said charge being collected, comprising:
receiving means connected to a terminal used by said user to view said information for receiving from said terminal first data for specifying information received by said user;
collecting means for collecting said charge for provision of information from said user based on said first data; and
transmitting means connected to said receiving means and said collecting means for transmitting to a first destination information of the charge collected by said collecting means in accordance with said first data.

8. A charge processing device that collects a charge for provision of information from a user receiving said information and processes said charge being collected, comprising:
receiving means connected to a terminal used by said user to view said information for receiving from said terminal first data for specifying information received by said user and second data for specifying said terminal;
collecting means for collecting said charge for provision of information from said user based on said first data; and
transmitting means connected to said collecting means and said receiving means for transmitting information of the charge collected by said collecting means to a first destination and a second destination separately in accordance with said first data and said second data.

9. The charge processing device according to claim 8, wherein
said receiving means includes means for receiving third data for specifying a distributor of information received by said user, in addition to said first data and said second data, and
said transmitting means includes means for transmitting said information of the charge to a first destination, a second destination and a third destination separately in accordance with said first data, said second data and said third data.

10. The charge processing device according to claim 7 or 8, wherein
said transmitting means includes means for transmitting said information of the charge to one separated from said first destination that is involved in creation of said information and is permitted to receive said information of the charge, in accordance with said first data.

11. The charge processing device according to claim 8, wherein
said transmitting means includes means for transmitting said information of the charge to one separated from said second destination that is involved in at least one of development and sale of said terminal and is permitted to receive said information of the charge, in accordance with said second data.

12. The charge processing device according to claim 7 or 8, wherein
said information includes data representing contents of information and advertising data, and said collecting means includes means for collecting an advertising fee from an advertiser of said advertising data, in addition to said charge for provision of information from said user, and
said transmitting means includes means for transmitting information of said charge and said advertising fee collected by said collecting means, to said destinations separately.

13. A charge processing method of collecting a charge for provision of information from a user receiving said information and processing said charge being collected, comprising the steps of:
receiving first data for specifying information received by said user from a terminal used by said user to view said information;
collecting said charge for provision of information from said user based on said first data; and
transmitting to a first destination information of the charge collected at said step of collecting the charge, in accordance with said first data.

14. A charge processing method of collecting a charge for provision of information from a user receiving said information and processing said charge being collected, comprising the steps of:
receiving from a terminal used by said user to view said information first data for specifying information received by said user and second data for specifying said terminal;
collecting said charge for provision of information from said user based on said first data; and
transmitting information of the charge collected at said step of collecting the charge to a first destination and a second destination separately in accordance with said first data and said second data.

15. The charge processing method according to claim 14, wherein
said step of receiving first data and second data includes a step of receiving third data for specifying a distributor of information received by said user, in addition to said first data and said second data, and
said step of transmitting information of the charge includes a step of transmitting said information of the charge to a first destination, a second destination and a third destination separately in accordance with said first data, said second data and said third data.

16. The charge processing method according to claim 13 or 14, wherein
said step of transmitting information of the charge includes a step of transmitting said information of the charge to a creator and a publisher of said information, separated from said first destination in accordance with said first data.

17. The charge processing method according to claim 14, wherein
said step of transmitting information of the charge includes a step of transmitting said information of the charge to a hardware producer and a software producer of said terminal, separated from said second destination in accordance with said second data.

18. The charge processing method according to claim 13 or 14, wherein
said information includes data representing contents of information and advertising data, and said step of collecting the charge includes a step of collecting an advertising fee from an advertiser of said advertising data, in addition to said charge for provision of information from said user, and
said step of transmitting information of the charge includes a step of transmitting information of said charge and said advertising fee collected at said step of collecting the charge, to said destinations separately.

19. A computer readable recording medium storing a program implementing a charge processing method of collecting a charge for provision of information from a user receiving said information and processing said charge being collected, said charge processing method including the steps of:
receiving first data for specifying information received by said user from a terminal used by said user to view said information;
collecting said charge for provision of information from said user based on said first data; and
transmitting to a first destination information of the charge collected at said step of collecting the charge, in accordance with said first data.

20. A computer readable recording medium storing a program implementing a charge processing method of collecting a charge for provision of information from a user receiving said information and processing said charge being collected, said charge processing method including the steps of:
receiving from a terminal used by said user to view said information first data for specifying information received by said user and second data for specifying said terminal;
collecting said charge for provision of information from said user based on said first data; and
transmitting information of the charge collected at said step of collecting the charge to a first destination and a second destination separately in accordance with said first data and said second data.

21. The recording medium according to claim 20, wherein
said step of receiving first data and second data includes a step of receiving third data for specifying a distributor of information received by said user, in addition to said first data and said second data, and
said step of transmitting information of the charge includes a step of transmitting said information of the charge to a first destination, a second destination and a third destination separately in accordance with said first data, said second data and said third data.

22. The recording medium according to claim 19 or 20, wherein
said step of transmitting information of the charge includes a step of transmitting said information of the charge to a creator and a publisher of said information, separated from said first destination in accordance with said first data.

23. The recording medium according to claim 20, wherein
said step of transmitting information of the charge includes a step of transmitting said information of the charge to a hardware producer and a software producer of said terminal, separated from said second destination in accordance with said second data.

24. The recording medium according to claim 19 or 20, wherein
said information includes data representing contents of information and advertising data, and said step of collecting charge includes a step of collecting an advertising fee from an advertiser of said advertising data, in addition to said charge for provision of information from said user, and
said step of transmitting information of the charge includes a step of transmitting information of said charge and said advertising fee collected at said step of collecting the charge, to said destinations separately.
